(19) United States
(12) Patent Application Publication
(10) Pub. No.: US 2013/0321241 A1
(43) Pub. Date: Dec. 5, 2013

(54) INTERFACE CARD AND ANTENNA FIXTURE STRUCTURE OF COMMUNICATION MODULE

(71) Applicant: Yu-Wei LIN, New Taipei City (TW)

(72) Inventor: Yu-Wei LIN, New Taipei City (TW)

(73) Assignee: GRAND-TEK TECHONOLOGY., LTD.

(21) Appl. No.: 13/486,905

(22) Filed: Jun. 1, 2012

(51) Int. Cl. H01Q 1/50

(52) U.S. Cl. 343/906

(57) ABSTRACT

In an interface card and antenna fixture structure of a communication module, an interface card includes a printed circuit board, a circuit module, a plurality of pins, and an antenna connector, and the antenna is conductively coupled to the antenna connector, and the pressing component is disposed on the printed circuit board and installed at a corresponding connecting position of the antenna and the antenna connector, and the locking component is passed through the pressing component and the printed circuit board and coupled to the motherboard, such that the pressing component presses the antenna and the antenna connector.

### FIELD OF THE INVENTION

The present invention relates to an antenna fixture structure, in particular to an interface card and antenna fixture structure of a communication module.

### BACKGROUND OF THE INVENTION

Since the computer industry blooms, various external devices such as screens, speakers and network cables are developed quickly according to user requirements, in addition to internal devices of the computers such as motherboards, memories and central processing units (CPUs). To connect the external devices to the computers, communication is established between the external devices and the computer, such that users can use the external devices through the computer.

In 2004, Intel introduced a peripheral component interconnect express (PCI-E) interface that can be installed on a quicker serial communication system to provide quicker speed and support the plug-n-play function, so that the PCI-E interface almost replaces all internal buses in a computer motherboard quickly. Since then, almost all external computer devices adopt the PCI-E interface card to connect to the computer motherboard.

With reference to FIG. 1 for a traditional way of connecting an interface card and an antenna, the interface card 10a is inserted into a slot 21a of a motherboard 20a to form a communication module 1a. In addition, the interface card 10a includes an antenna 30a extended outwardly from the interface card 10a, and the way of connecting the interface card 10a and the antenna 30a is to install an antenna connector 11a on the interface card 10a for connecting the antenna 30a to achieve the functions of transmitting and receiving wireless signals. However, during the process of transporting the communication module 1a, the antenna connector 11a of the interface card 10a and the antenna 30a may be separated easily due to vibrations, thus resulting in a poor electric connection between the interface card 10a and the antenna 30a. Obviously, such conventional way of connecting the interface card and the antenna requires improvements.

In view of the foregoing problems of the prior art, the inventor of the present invention conducted extensive researches and experiments, and finally provided a feasible design to overcome the problems.

### SUMMARY OF THE INVENTION

Therefore, it is a primary objective of the present invention to provide an interface card and antenna fixture structure of a communication module used for preventing the interface card and the antenna from being separated from each other to maintain a good electrical connection between the interface card and the antenna.

To achieve the foregoing objective, the present invention provides an interface card and antenna fixture structure of a communication module, wherein the fixture structure is mounted on a motherboard, and the communication module comprises an interface card, an antenna, a pressing component and a locking component, and the interface card comprises a printed circuit board, a circuit module installed on the printed circuit board, a plurality of pins electrically coupled to the motherboard, and an antenna connector electrically coupled to the circuit module, and the antenna is conductively coupled to the antenna connector, and the pressing component is disposed on the printed circuit board and installed at a corresponding conductive connecting position of the antenna and the antenna connector, and the locking component is passed through the pressing component and the printed circuit board and coupled to the motherboard, such that the pressing component presses against the conductive connecting position of the antenna and the antenna connector.

Another objective of the present invention is to provide an interface card and antenna fixture structure of a communication module, wherein a pressing component and a locking component are used to fix the interface card at the conductive connecting position of the antenna to achieve a quick, simple and easy assembling process.

Compared with the prior art, the communication module of the present invention further includes a pressing component and a locking component for pressing against the conductive position of the interface card and the antenna to maintain a stable connection between the interface card and the antenna, such that the interface card and the antenna will not be separated easily due to the vibrations or other external forces occurred during a moving or transportation process, so as to maintain a good electric connection between the interface card and the antenna and enhance the practicality of the application.

### BRIEF DESCRIPTION OF THE DRAWINGS

FIG. 1 is a schematic view of a traditional way of connecting an interface card and an antenna;

FIG. 2 is a perspective view of an interface card and antenna fixture structure of a communication module in accordance with the present invention;

FIG. 3 is an exploded view of an interface card and antenna fixture structure of a communication module in accordance with the present invention; and

FIG. 4 is a cross-sectional view of an interface card and an antenna of a communication module in accordance with the present invention.

### DESCRIPTION OF THE PREFERRED EMBODIMENTS

The details and technical contents of the present invention will become apparent with the description of the following preferred embodiments accompanied with the illustration of the related drawings as follows. However, the drawings are provided for reference and for the purpose of illustrating the present invention only, but not intended for limiting the scope of the invention.

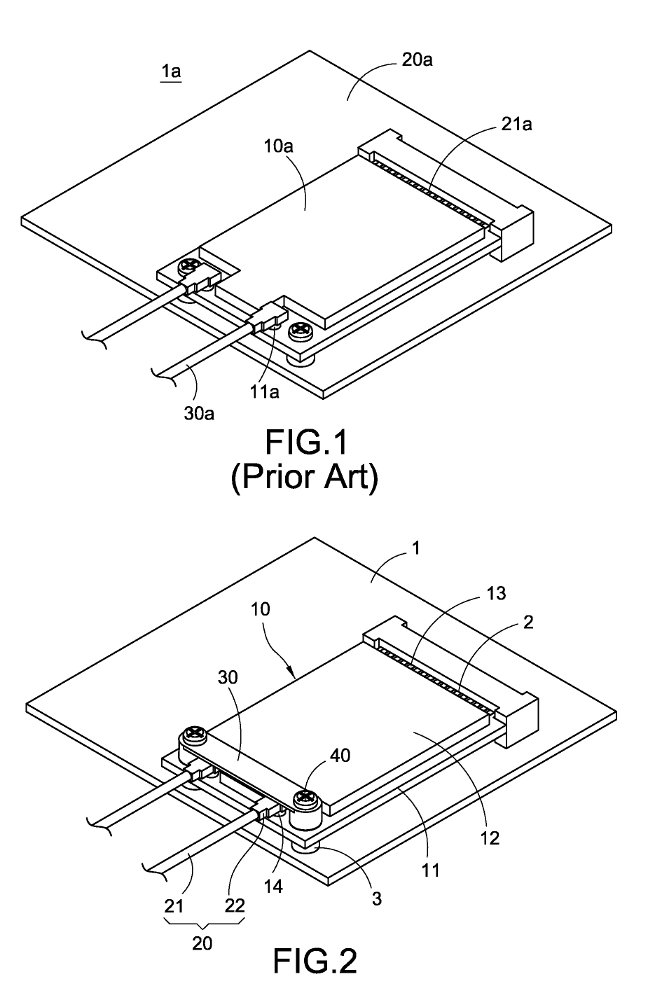

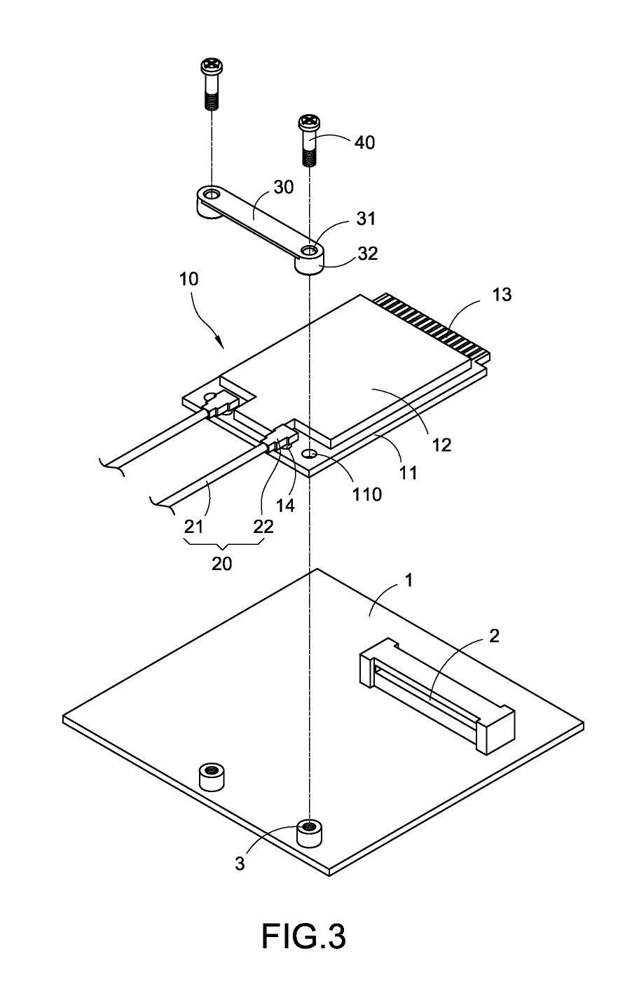

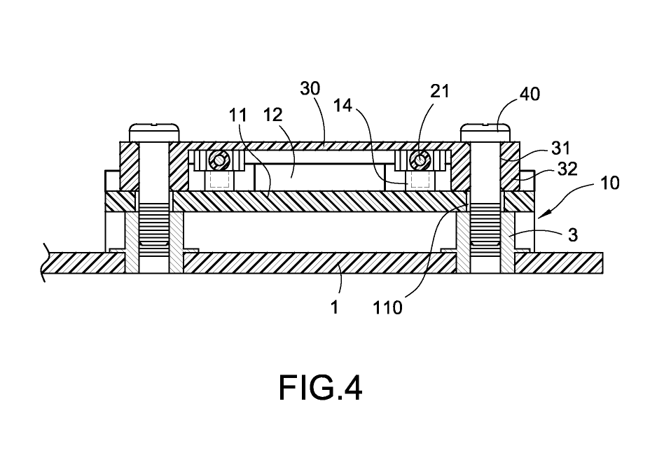

With reference to FIGS. 2 to 4 for a perspective view, an exploded view, and a cross-sectional view of an interface card and antenna fixture structure of a communication module in accordance with the present invention respectively, the interface card and antenna fixture structure is mounted on a motherboard 1, and the communication module comprises an interface card 10, an antenna 20, a pressing component 30, and a locking component 40.

The interface card 10 is a PCI-E interface card or a mini PCI-E interface card, but the invention is not limited to such arrangement only. The interface card 10 comprises a printed circuit board 11, a circuit module 12 installed on the printed circuit board 11, a plurality of pins 13 electrically coupled to the motherboard 1, and an antenna connector 14 electrically coupled to the circuit module 12, wherein the pins 13 are installed at a lateral end of the printed circuit board 11, and the circuit module 12 and the pins 13 are electrically coupled to the printed circuit board 11, and the motherboard 1 has a slot 2 for inserting the pins 13 therein.

The antenna 20 is conductively coupled to the antenna connector 14. In this preferred embodiment, the interface card 10 of the communication module comprises two antenna connectors 14 and two sets of antennas 20, and the two sets of antennas 20 are respectively and conductively coupled to the two antenna connectors 14. The antenna 20 comprises a cable 21 and a conductive connector 22 at an end of the cable 21, and the two sets of antennas 20 are installed in the same structure. The conductive connector 22 is electrically connected to the antenna connector 14, and the other antenna 20 is electrically connected to the other antenna connector 14.

The pressing component 30 is disposed on the printed circuit board 11, and installed at a corresponding conductive connecting position of the antenna 20 and the antenna connector 14. In addition, the motherboard 1 has a plurality of screw holes 3 for locking the interface card 10. In this preferred embodiment, the pressing component 30 is a pressing plate, and the pressing component 30 includes a plurality of connecting holes 31 formed at positions corresponding to the screw holes 3 respectively, and a socket 32 formed at the connecting holes 31 on the bottom surface of the pressing plate 30, and the socket 32 is pressed against the printed circuit board 11, and the bottom surface of the pressing plate 30 presses against the conductive connector 14.

In addition, the locking component 40 is passed through the pressing component 30 and the printed circuit board 11 and coupled to the motherboard 1, such that the pressing component 30 presses against the conductive connecting position of the antenna 20 and the antenna connector 14. In an actual assembling process, the locking component 40 can be a screw (but is not limited to the screw only), and the quantity of locking components 40 is determined according to the quantity of antenna connectors 14 and antennas 20.

In addition, the printed circuit board 11 includes a plurality of through holes 110 formed at positions corresponding to the screw holes 3 respectively, and the locking components 40 are passed through the connecting holes 31 and the through holes 110, and screwed into the screw holes 3 respectively, so as to complete the process of fixing the interface card 10 of the communication module with the antenna 20 and achieve the effects of preventing the interface card 10 and the antenna 20 from being separated from each other easily during the transportation or moving process due to vibrations or other external forces, and maintaining a good electric connection between the interface card 10 and the antenna 20.

While the invention has been described by means of specific embodiments, numerous modifications and variations could be made thereto by those skilled in the art without departing from the scope and spirit of the invention set forth in the claims.

What is claimed is:

1. An interface card and antenna fixture structure of a communication module, mounted on a motherboard, and the communication module comprising:
an interface card, including a printed circuit board, a circuit module installed on the printed circuit board, a plurality of pins electrically coupled to the motherboard, and an antenna connector electrically coupled to the circuit module;
an antenna, conductively connected to the antenna connector;
a pressing component, disposed on the printed circuit board, and installed at a conductive connecting position of the antenna and the antenna connector; and
a locking component, passed through the pressing component and the printed circuit board and coupled to the motherboard, such that the pressing component presses at the conductive connecting position of the antenna and the antenna connector.

2. The interface card and antenna fixture structure of a communication module as recited in claim 1, wherein the circuit module and the pins are electrically coupled to the printed circuit board.

3. The interface card and antenna fixture structure of a communication module as recited in claim 2, wherein the motherboard has a slot, and the pins are installed on a side of the printed circuit board and inserted into the slot.

4. The interface card and antenna fixture structure of a communication module as recited in claim 1, wherein the antenna comprises a cable and a conductive connector coupled at an end of the cable and electrically connected to the antenna connector.

5. The interface card and antenna fixture structure of a communication module as recited in claim 4, wherein the communication module comprises two sets of antennas, and the interface card comprises two antenna connectors, and the two sets of antennas are respectively and conductively connected to the two antenna connectors.

6. The interface card and antenna fixture structure of a communication module as recited in claim 5, wherein the motherboard includes a plurality of screw holes for locking the interface card, and the pressing component is a pressing plate, and the pressing component includes plurality of connecting holes formed at positions corresponding to the screw holes respectively.

7. The interface card and antenna fixture structure of a communication module as recited in claim 6, wherein the printed circuit board includes a plurality of through holes formed at positions corresponding to the screw holes respectively, and the locking components are passed through the connecting holes and the through holes and screwed into the screw holes respectively.

8. The interface card and antenna fixture structure of a communication module as recited in claim 6, wherein the pressing plate includes a socket formed at the bottom of the pressing plate and at the position corresponding to the connecting holes and abutted against the printed circuit board, and the bottom of the pressing plate presses against the conductive connector.

9. The interface card and antenna fixture structure of a communication module as recited in claim 6, wherein the locking component is a screw.
